(19) United States
(12) Patent Application Publication
(10) Pub. No.: US 2007/0204908 A1
(43) Pub. Date: Sep. 6, 2007

(54) High purity carbon dioxide delivery system using dewars

(75) Inventors: Kimber D. Fogelman, Hockessin, DE (US); Vincent L. Worley, Wilmington, DE (US); Paul S. Bracher, Newark, DE (US)

Correspondence Address: STANDLEY LAW GROUP LLP, 495 METRO PLACE SOUTH, SUITE 210, DUBLIN, OH, 43017, US

(73) Assignee: Mettler-Toledo AutoChem, Inc., Newark, DE (US)

(21) Appl. No.: 11/709,288

(22) Filed: Feb. 22, 2007

Related U.S. Application Data
(60) Provisional application No. 60/775,758, filed on Feb. 22, 2006.

(51) Int. Cl. E03B 1/00; A23L 2/00; F17C 7/04; F25J 3/00

(52) U.S. Cl. 137/12; 62/617; 62/48.1; 137/12.5

(57) ABSTRACT

In delivery of bulk liquefied gas under pressure from portable containers, the claimed invention provides a system and process for directing the evaporated vapor from one or more satellite pressure vessels through a master vessel. The gas transfer operates passively to provide for longer unattended run times for a downstream application. The master vessel serves as a trap for the incoming gas vapor, and thereby improves the overall vapor quality by re-equilibrating the vapor with the colder bulk liquid in the master vessel before delivery to the destination application.

### CROSS-REFERENCE TO RELATED APPLICATIONS

The present application claims the benefit of Provisional U.S. Patent Application Ser. No. 60/775,758 filed on Feb. 22, 2006 by Kimber D. Fogelman, et al for CARBON DIOXIDE DELIVERY SYSTEM USING DEWARS.

### FIELD OF THE INVENTION

The present invention relates to gas delivery systems providing delivery of a pressurized combustible or non-combustible gas from a storage vessel or tank.

### BACKGROUND OF THE INVENTION

Pressurized combustible or non-combustible liquefied gas from a supply vessel or tank is required for a variety of industrial and commercial processes. Gas is typically kept in one or more pressurized storage vessels or tanks located inside or outside of a facility. Purified non-combustible gas, such as carbon dioxide, is typically stored in liquefied form in a battery of cylinders that are stored near the equipment or process using the gas.

Commercial grades of liquefied carbon dioxide range in purity from 98% to 99.9999%. The cost ratio between the highest and lowest purity can be as high as 20-fold per unit weight of liquid. Two methods are commonly used to extract gaseous CO2 from storage tanks and cylinders. These methods have very different effects on output purity. In the first method, carbon dioxide liquid is extracted via dip tube from the reservoir and passed through a vaporizer device that passively or actively adds heat to the liquid stream to provide the phase change to vapor. This method is referred to as an evaporate-to-process method. All components of the extracted bulk liquid become entrained in the output flow stream. In this case, the purity of the vapor stream is representative of the bulk purity of the liquid carbon dioxide and may contain entrained liquid and particulate impurities contained in the bulk carbon dioxide. In addition, lubricants or extractable components of seals used in valves of the storage vessel may become dissolved into the liquid carbon dioxide as it fills or emerges from the reservoir. To get very high output purity, the bulk purity of the liquid must also be high and special care must be taken with the purity of all fluidic components. An advantage of the evaporate-to-process method is that it generally easier to provide the heat necessary for liquid carbon dioxide evaporation outside of the cryogenic region of the container. As a result, evaporate-to-process extractions can support very high flow demands by the process.

In a second method of extraction, the vapor headspace over the bulk liquid is removed. Lost vapor is replenished by some combination of evaporation from the bulk liquid surface or using a pressure builder device which essentially directs liquid through a vaporizer and back to the vapor space of the container in a pressure regulated manner. Once it is returned to the vapor headspace region of the container, the carbon dioxide gas has an opportunity to re-equilibrate with the bulk liquid surface. This method is referred to as headspace or vent extraction. A major advantage of headspace extraction is that the vapor phase generally contains only those components that are volatile at the cryogenic temperatures of the cryogenic container [typically −10 to −40 C]. No liquid or particulate impurities are removed from the container. As a result, the purity of the headspace carbon dioxide vapor, even over the lowest grade of bulk carbon dioxide, may approach the purity of the highest purity bulk grade of liquid carbon dioxide. Thus, there is a strong economic incentive for using the headspace extraction method since it provides very high purity carbon dioxide at the dramatically lower cost of low purity bulk liquid. For permanent installations of carbon dioxide bulk tanks at a process site, it is common to provide active heating of the bulk carbon dioxide liquid to provide a constant pressure of high purity headspace within the tank which may then be extracted for the process stream.

Where transportable gas vessels are needed at a facility, the storage vessels are characterized by high pressures, 800-1300 psi, and low pressure, 125-300 psi. High pressure cylinders are typically limited to relatively small volumes of liquid carbon dioxide [e.g. 40 to 70 pounds per cylinder] of which approximately 75 to 80% is extractable at the elevated pressure. Such cylinders are not suitable when a relatively high demand for carbon dioxide vapor at a constant pressure exists. Low pressure cylinders, also referred to as cryogenic dewars, typically have liquid capacities of 350 to 1000 pounds of which between 80 and 90% is accessible at the stated pressure range. These vessels are designed to store cryogenic liquid carbon dioxide at pressures up to 350 psi. They provide three valved fittings as a means of extracting carbon dioxide from the reservoir. These extraction flow paths are the Liquid withdrawal circuit, the Gas withdrawal circuit and the Vent circuit.

FIG. 1 illustrates the features of a typical cryogenic dewar cylinder. Dewar 10 has a cylindrical outer vessel body 12 and a cylindrical inner chamber 14. Chamber 14 contains a liquefied gas 18, such as carbon dioxide, and vaporized gas headspace 16 in dynamic equilibrium. Removal of either liquid or vapor from the inner chamber 14 creates an equilibrium imbalance that must be balanced by generation of more carbon dioxide vapor into the headspace 16. If the evaporation occurs directly from the surface of liquid 18, the liquid will cool and reduce the amount of total gas that is evaporated. The cooler liquid 18 will reduce the total pressure of the headspaces 16.

Both liquid and gas withdrawal are possible from cryogenic dewar 10. In both cases, flow out of the dewar depends on the pressure of the vapor headspace 16 being greater than the downstream pressure of the process being supplied. If the downstream pressure is greater, either no flow will occur, if the vessel is suitably isolated by check valves, or flow will reverse and enter the cryogenic dewar. Downstream processes that require higher pressure than the dewar can deliver must employ additional pumping devices to boost the pressure. In order to maintain pressure within dewar 10 as gas or liquid is removed, a pressure builder circuit 20 consisting of a low capacity vaporizer 22 inserted at the bottom of inner chamber 14 which draws heat through the outer chamber 12 wall and passes vapor upward to an isolation valve 24 and through a pressure-balancing regulator 26 and returns into the vapor headspace 16 of inner chamber 14. When valve 24 is opened and headspace 16 pressure drops below the threshold of the pressure-balancing regulator 26 the regulator opens and admits liquid into the lower portion of the vaporizer 22. The liquid draws heat through outer wall 12 and evaporates. The vaporized carbon dioxide continues to fill the headspace until the pressure rises to the regulator 26 threshold which then closes the flow path. Excess liquid in the vaporizer tubing is forced back into the bulk liquid 18 as a small amount of that liquid continues to vaporize and fill tube 22. The pressure builder circuit can evaporate between 3 and 5 pounds per hour in typical dewar cylinders.

Liquid may be drawn directly from dewar 10 by means of liquid withdrawal circuit 28 which consists of dip tube 30 positioned near the bottom of the inner chamber 14. The dip tube is connected to valve 32 which when opened allows the pressure from headspace 16 to force liquid from inner chamber 14 out of the dewar 10.

Gas may be drawn from dewar 10 by two means. The Gas withdrawal circuit 34 shares dip tube 30 with liquid withdrawal circuit 28. The flow path branches to a high capacity vaporizer 36 which allows heat transfer through the outer chamber 12 wall then to isolation valve 38 and out of the dewar. Opening valve 38 initiates an evaporate-to-process flow stream in which liquid carbon dioxide is forced by the internal headspace pressure into vaporizer 36 and evaporated. The vapor and entrained impurities exit the dewar and in normal use are directed to the process stream. The high capacity vaporizer is nominally rated to deliver 18 pounds per hour of carbon dioxide vapor. If the process demand is greater than the vaporizer can evaporate, liquid carbon dioxide will emerge from valve 38.

The final means of withdrawing vapor from dewar 10 is through the Vent flow path 40. This flow path consists of a simple vent tube 42 in communication with the top most region of the vapor headspace 16 of inner chamber 14. The tube continues out of dewar 10 to valve 44. Opening valve 44 forces the high purity headspace vapor out the vent flow path 40. If vapor is withdrawn faster than the pressure builder circuit 20 can replace it [e.g., 3 to 5 pounds per hour], the headspace pressure will drop until it is below the require pressure for the process stream.

Not shown in FIG. 1 are several additional features of standard dewars. These include a level indicator, a pressure gauge and several safety venting devices to prevent the inner chamber 14 from rupturing due to overpressurization. In addition, an economizer flow path connects the Gas Out flow path 34 with the pressure builder regulator 26 to allow gas to be drawn from the headspace 16 when the headspace pressure exceeds the regulator threshold. For the purposes of the preferred and alternative embodiments, any further references to dewars include the typical vessels and constituent components referenced by FIG. 1 and their equivalents. References to the various withdrawal circuits include typical constituent parts of each circuit and equivalents.

If a continuous carbon dioxide flow stream is needed in a process at a certain pressure, one or more dewars can be arranged to deliver flow. If the liquid carbon dioxide purity is sufficient, the dewars can be combined in an evaporate-to-process manner as shown in FIG. 2. In this figure three dewars, 10, 50 and 70, are arranged to deliver carbon dioxide vapor to a downstream process 100 via their respective Gas withdrawal circuits, 34, 60 and 80. Only the main features of each dewar are displayed for clarity. Each Dewar 10, 50 and 70 is connected to an individual port of a passive manifold 90 through a transfer line that includes passive check valves, 46, 66 and 86 respectively, to prevent return flow. Flow continues toward the downstream process 100 from manifold 90.

Dewars 10, 50 and 70 are connected in a parallel flow configuration as a bank of dewars. As a result, if the three dewars have the same internal pressure in headspaces 16, 56 and 76 respectively and check valves 46, 66 and 86 have the same cracking pressure and flow restriction, the three dewars will each contribute identical flow volumes and drain at the same rates. In this case, up to 54 pounds per hour may be extracted from the bank of three dewars without further treatment of the vapor stream. This condition is almost never achieved, however. When the internal headspace pressure of any dewar [e.g. 10] exceeds the others, that pressure will tend to close the other check valves [e.g. 66 and 86] and only a single dewar will deliver gas flow to the process. If this demand is exceeded, the Gas withdrawal circuit's vaporizer is unable to keep up with the required evaporation rate and cryogenic liquid will emerge from one of the Gas withdrawal circuits 34, 60 or 80 until the pressure of that dewar approaches or drops below one of the others in the bank. The event may be handled by inclusion of an additional auxiliary vaporizer 92 within the flow stream prior to the downstream process 100. On the positive side, the system shown in FIG. 2 can operate for a substantial period of time with high flow demand until the internal pressure in all the vessels fall below the minimum pressure and flow requirements. At that point the dewars 10, 50 and 70 must be replaced and returned to a supplier for refilling. On the negative side, it is generally difficult to obtain bulk quantities of cryogenic liquid carbon dioxide of certified high purity while such quantities of lower purity carbon dioxide are readily available. For processes that actually require the higher purity streams, the evaporate-to-process system in FIG. 2 may be undesirable without significant conditioning of the vapor stream before it reaches the downstream process.

FIG. 3 shows the same dewars used in FIG. 2 arranged in a headspace extraction configuration. In this configuration, dewars 10, 50 and 70 deliver carbon dioxide vapor from their respective Vent circuits 40, 62 and 82 through check valves 46, 66 and 86 to manifold 90. From the manifold 90, the vapor is delivered to the downstream process 100. The carbon dioxide vapor is removed directly from the partially equilibrated headspaces 16,56 and 76 over the cryogenic liquid of the reservoir and thus is typically very high in purity, even when the bulk liquids 18, 58 and 78 contain significant dissolved liquid, solid or particulate impurities. Vapor withdrawn from headspaces 16, 56 and 76 must be replaced entirely by the pressure builder circuits of the dewars [not shown] or by evaporation from the surface of the bulk fluid. This represents a rather severe restriction of the arrangement in FIG. 3, since the capacity of pressure builder circuits typically is only 3 to 5 pounds per hour due to their small vaporizer size, while evaporation form the bulk liquid cools the liquid and reduces the headspace pressure. Thus in the optimal case, the bank of three dewars on FIG. 3 can only deliver approximately 15 pounds per hour in a continuous manner, a smaller amount than a single dewar in the evaporate-to-process configuration. Unlike the former configuration in FIG. 2, headspace extraction shown in FIG. 3 delivers higher purity carbon dioxide and cannot inadvertently deliver liquid carbon dioxide into the vapor flow stream at high demands from the down stream process. Instead, when headspace vapor is drawn off faster than the pressure builder circuit can replenish it, the internal pressure of the dewar drops until it is below the process requirement. The result is a bank of dewars considered “empty” by the system that can actually contain significant amounts of liquid carbon dioxide. This is a waste of resources and very inconvenient since level gauges for dewars are unreliable and dewars are returned with very little of their contents used. This significantly increases the operating cost of the high purity system.

Maintaining an uninterrupted gas flow stream for the process requires switching the pressurized supply line from the “empty” bank of dewars to a full bank. FIG. 3 demonstrates this capability. The dewars may be connected to a PLC (Programmable Logic Controller)-based electromechanical valve interface 96 that monitors the inlet pressure of each dewar or bank. If the pressure from a bank falls below the pressure requirements of the process receiving the gas flow stream, for example a 200 psig intake flow stream requirement, the bank is considered depleted and switched off. The PLC interface 94 switches the flow stream to feed from an auxiliary bank of dewars 98 that has a suitable pressure measurement. When all the banks of dewar tanks are depleted or reach a low pressure threshold, then an error is condition is generated. The described dewars in FIG. 3 have been used to maintain non-combustible gas delivery volumes for applications such as processes requiring 70 mL/min or less of carbon dioxide gas. At this demand rate both two and three dewar banks have been successfully employed in providing high purity carbon dioxide vapor from lower purity, bulk carbon dioxide liquid. Applications requiring higher demands of gas, such as up to 200 mL/min or 24 lb/hour, create high demands and logistical problems on gas supplies. Further, such applications requiring a high flow rate of carbon dioxide at 200 psig creates too a high demand on the pressure builder circuits that causes a relatively rapid decline in the operation pressure of each gas supply vessel. As described earlier, the banks appear depleted long before all the liquid carbon dioxide has been used.

Frequently, the downstream process 100 requires higher pressure gas or liquid than the dewars are able to provide. In this case, the downstream process 100 includes a pressure boosting system to pressurize or re-liquefy the vapor provided by the gas delivery system. A standard commercial gas boosting system supplying carbon dioxide into a process is capable of delivering up to 36 lb/hr (300 mL/min) of minimum 1200 psi carbon dioxide if the flow stream is supplemented with approximately twenty horsepower of air from pump 50 at 115 psi and a continuous supply of carbon dioxide supply of 300 psi. The base system can be extended to a capacity of approximately 60 lb/hr (500 mL/min) with the addition of a preboost pump. Hence the capacity exists in the downstream process for flows much greater than demonstrated by either of the configurations shown in FIGS. 2 or 3.

FIGS. 2 and 3 represent typical installations of transportable vessels for vapor delivery from cryogenic tanks. In the first case, moderate to high capacity flow is available only if the bulk liquid is of acceptable purity. This can be a costly alternative given the high cost of certified high purity liquid. In the second case, high purity vapor is available from lower grades of cryogenic liquid, but at a reduced maximum flow rate. What is needed, then, is a portable vessel-based gas supply system with both high-capacity and high purity. While the discussion has used as a preferred embodiment carbon dioxide, the present invention applies to other embodiments of many combustible and non-combustible liquefied gasses that can be installed on commercial and industrial sites.

### SUMMARY

The preferred and alternative embodiments of the present invention provide a combustible and non-combustible liquefied gas supply system that can use transportable cryogenic vessels, such as dewars, and replaces the prior PLC-based bank-switch controller that supplies gas from banks of dewars connected by a parallel manifold. The embodiments use banks of two or three dewars with a combination of gas withdrawal modes to achieve a gas delivery system with both high purity and high capacity. In each bank of dewars both evaporate-to-process and headspace withdrawal methods are employed. Each bank is divided into two classes of dewars: a single master dewar and one or two satellite dewars. Satellite dewars use an evaporate-to process method to dramatically improve the heat transfer capacity of carbon dioxide vaporization. The withdrawn gas, representative of the bulk purity of the original liquid, is bubbled through the liquid reservoir of the master dewar in each bank. This method of bubbling acts to trap liquid, dissolved solid, or particulate impurities entrained in satellite dewar input stream. In addition, vapor impurities in the gas stream have an opportunity to re-equilibrate with the colder liquid of the master dewar which should lower these impurities as well. The master dewar then uses its vent circuit to deliver the purified carbon dioxide vapor to the downstream process.

The present invention results in use of between 80 and 90% of bulk liquid while providing a higher purity gas vapor to a downstream application. Further, the capacity of the invention to deliver gas to the downstream application is similar to the high capacity of an evaporate-to-process arrangement of dewars.

### BRIEF DESCRIPTION OF THE DRAWINGS

For a better understanding of the nature of the present invention, its features and advantages, the subsequent detailed description is presented in connection with accompanying drawings in which:

FIG. 1 is a diagram of a cryogenic dewar used in the prior art;

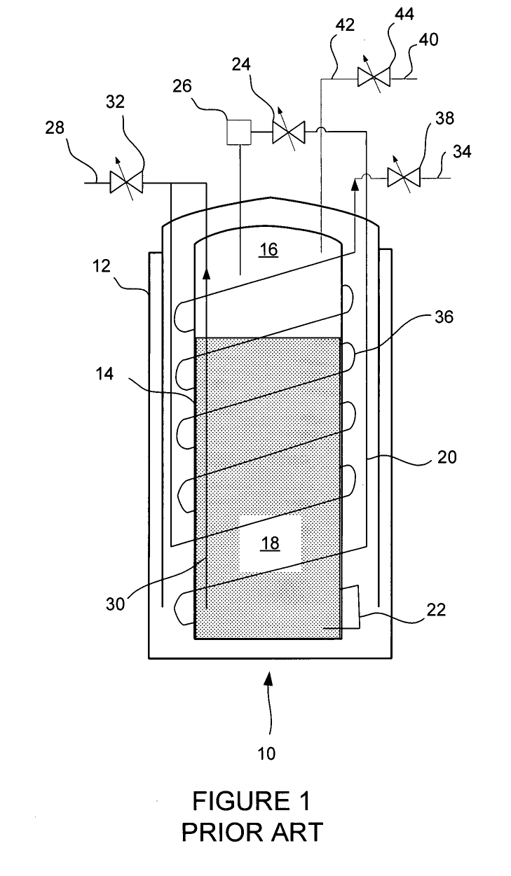

FIG. 2 is a diagram of a evaporate-to-process gas delivery system used in the prior art;

FIG. 3 is a diagram of a headspace extraction gas delivery system with PLC controlled bank switching used in the prior art;

FIG. 4 is a diagram of a gas delivery system of the preferred embodiment using two storage vessels;

FIG. 5 is a diagram of a gas delivery system of an alternative embodiment using three storage vessels;

FIG. 6 is a diagram of a gas delivery system of an alternative embodiment using multiple banks of storage vessels;

FIG. 7 is a flowchart of the preferred and alternative processes for gas delivery; and

FIG. 8 is a flowchart of an alternative process for gas delivery using multiple banks of storage vessels.

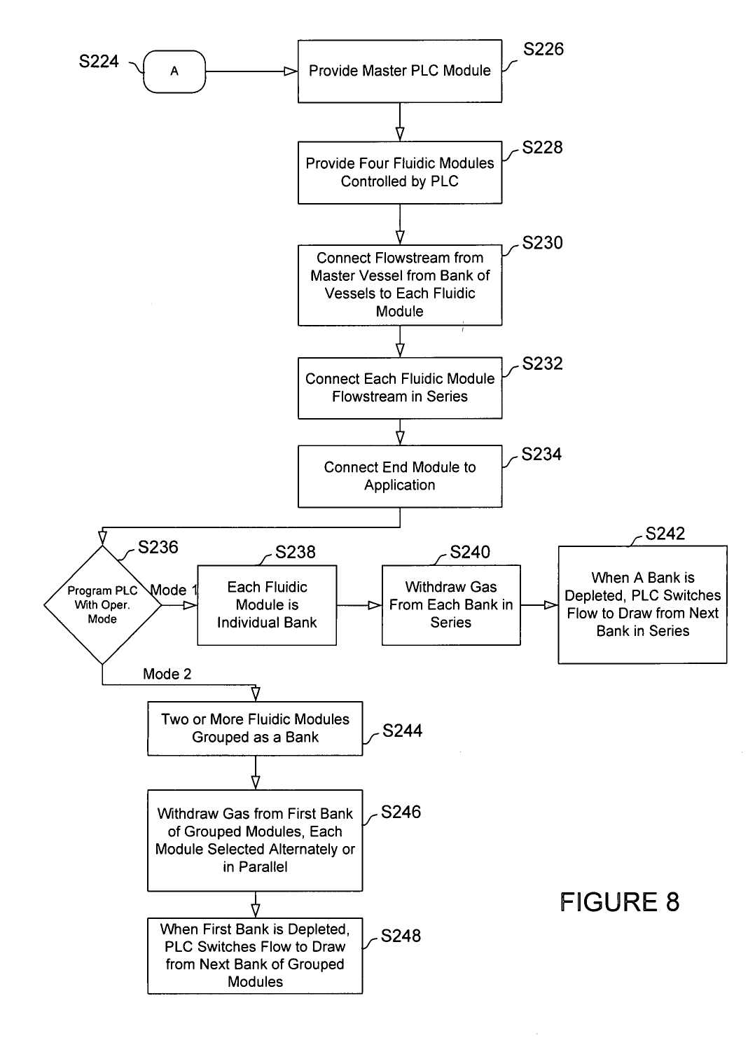

### DETAILED DESCRIPTION OF THE INVENTION

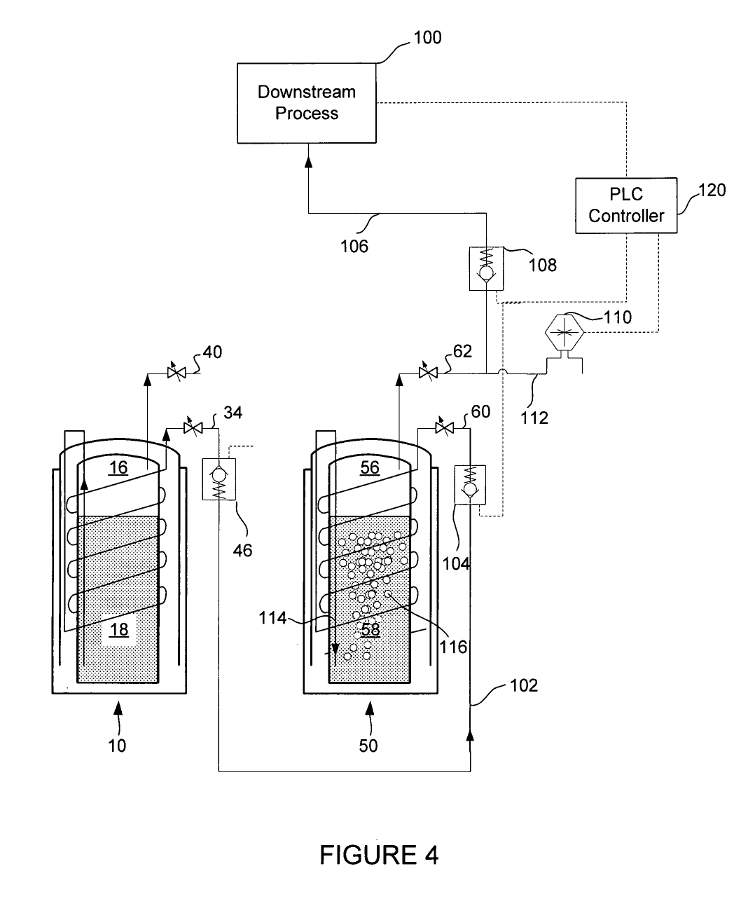

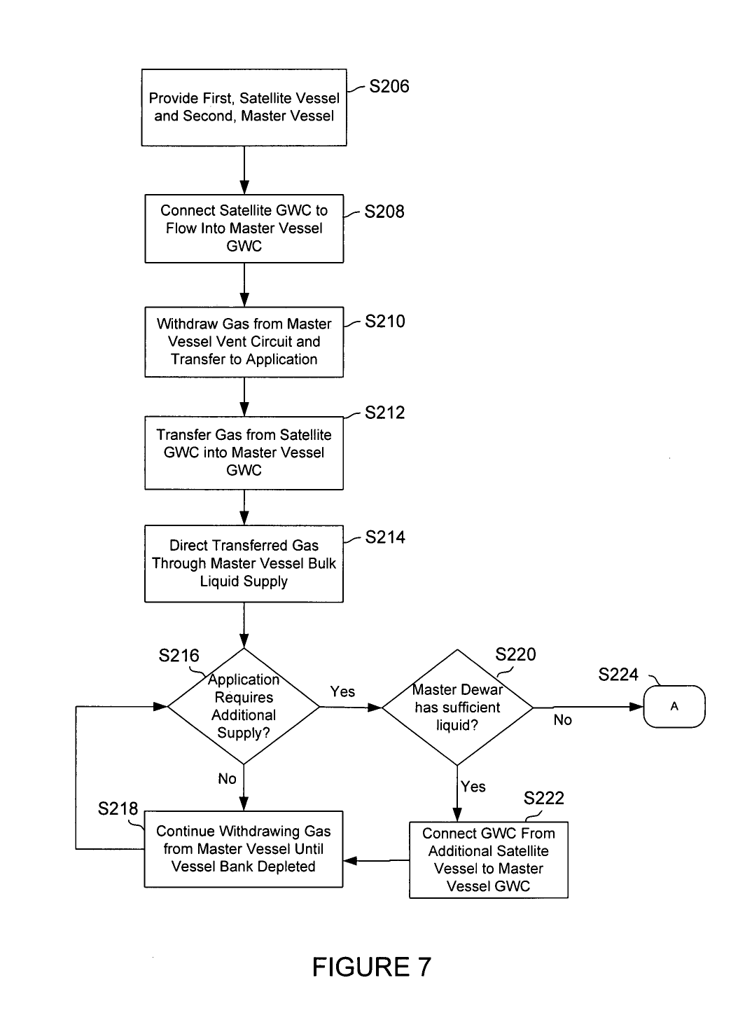

The preferred and alternative embodiments of the present invention describe systems and processes for providing combustible or non-combustible gas from portable, pressurized liquefied gas storage vessels or tanks, such as dewars. Referring to FIG. 4 and FIG. 7, the preferred embodiment for a gas supply system and preferred process for gas supply comprise supplying two dewar vessels: first dewar vessel 10, and second dewar vessel 50 arranged together S206 as a bank of storage vessels. Each dewar contains pressurized gas in liquid and vapor phases. For the purposes the embodiments, carbon dioxide is delivered as a gas to downstream process 100. It is understood however that the use of carbon dioxide is exemplary and that any combustible or non-combustible gas that may be stored as bulk liquid under pressure may be used in the present invention. Dewar 10 is a satellite dewar in the system and contains carbon dioxide under pressure in liquefied phase 18 in the bottom of the chamber and vapor phase 16 in the headspace of the chamber. A transfer line 102 is connected S208 between gas withdrawal circuit 34 of Satellite dewar 10 and gas withdrawal circuit 60 of Master dewar 50 The transfer line includes passive no-return check valve 46 near the exit of gas withdrawal circuit 34. Gas withdrawal circuit 34, transfer line 102 with valve 46, and gas withdrawal circuit 60 create a one-way flow path from liquid phase 18 of Satellite Dewar 10 to liquid phase 58 of Master Dewar 50. The flow path can have flow only when both gas withdrawal circuits 34 and 60 are open and the vapor pressure of headspace 16 in Dewar 10 exceeds that of headspace 56 in Dewar 50. Check valve 46 continuously prevents flow from proceeding in the opposite direction despite possible periods of higher vapor pressure in Master Dewar 50.

Dewars 10 and 50 also use pressure building circuits, not shown in FIG. 4, that attempt to maintain pressure in their respective headspaces 16 and 56 as bulk liquid 18 or headspace vapor 56 is lost from the respective dewars. Gas withdrawal circuit 40 from Dewar 10 is not used in the preferred embodiment.

Transfer line 106 creates a flow path that connects vent circuit 62 of master dewar 50 to the downstream process requiring gas at a known range of pressure and flow. When vent circuit 62 is open, gas is withdrawn S210, S218 from the vapor headspace 56 of Master dewar 50 to downstream process 100. The downstream process should provide safeguards to insure flow cannot be reversed from the process back to Master Dewar 50.

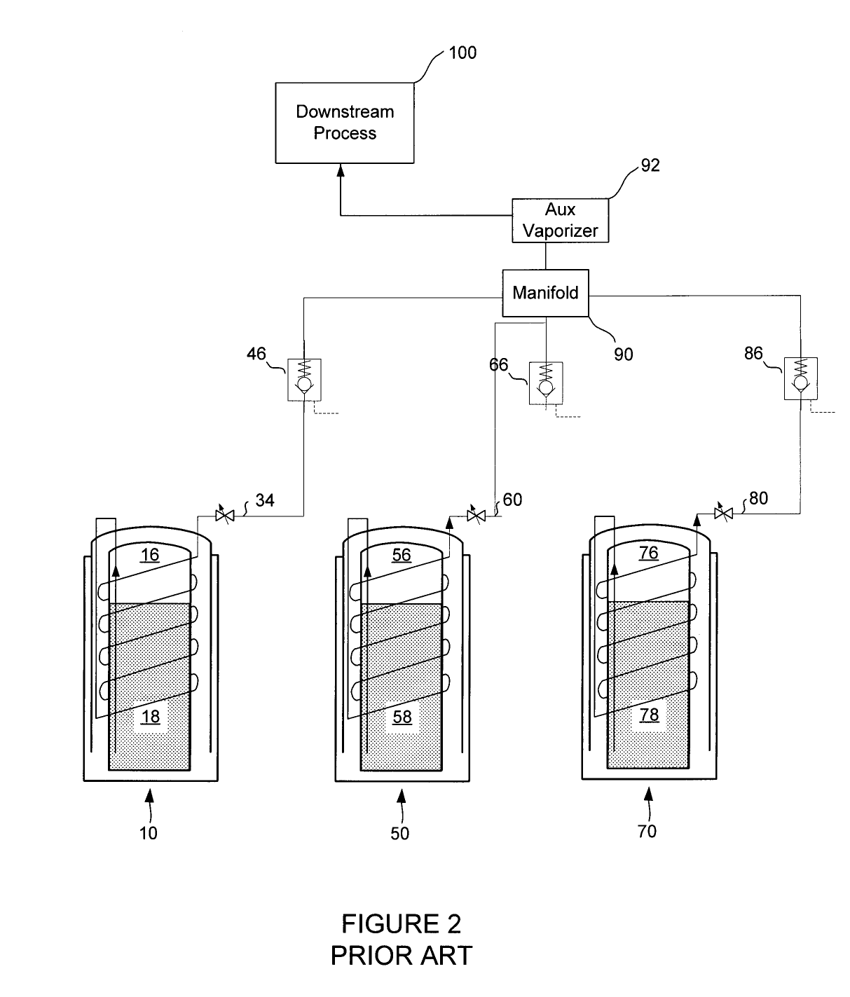

As gas is drawn by the process, pressure in headspace 56 drops enabling flow S212 from the liquid in Satellite dewar 10 to the liquid in satellite dewar 50. Liquid carbon dioxide enters gas withdrawal circuit 34 of Satellite dewar 10 on its path toward master Dewar 50. By the time of its arrival at the liquid phase 58 of Master dewar 50, the carbon dioxide has passed completely through two complete gas withdrawal circuits 34 and 60, each capable of vaporizing 18 pounds per hour. In addition, depending on its length and access to the ambient environment, transfer line 102 itself may provide significant additional vaporizing capacity. It should be noted that the direction of flow through gas withdrawal circuit 60 is reversed from normal operation. However, this does not have an effect on the circuit's ability to vaporize liquid carbon dioxide that enters it. Hence, with the stated capacity for evaporating carbon dioxide and for any demand of the downstream process less than approximately 36 pounds per hour, the carbon dioxide that leaves dewar 10 as a liquid, arrives at dewar 50 as a vapor. As the carbon dioxide vapor exits dip tube 114 of gas withdrawal circuit 60, it forms a stream of bubbles 116 that makes its way to the surface of liquid phase 58 and enters the vapor headspace 56 of master dewar 50. During its travel through liquid phase 58, the bubble stream 116 re-equilibrates with the liquid phase, losing nonvolatile components such as entrained liquids or dissolved solids carried in by the evaporate-to-process delivery from satellite dewar 10. In this regard, the liquid phase of the master cylinder acts as a trap for impurities. In addition, two other events result from the bubbling process. First, the liquid phase 58 of master dewar 50 is continuously stirred which minimizes the local concentration of these impurities and maximizes heat transfer from the dewar walls while gas is being extracted by the process. Second, any excess heat beyond the heat used to vaporize the carbon dioxide gas is delivered to the cooler liquid phase. The mixing action of the bubble stream also tends to distribute this heat throughout the bulk liquid. By transferring more heat to the bulk liquid of Dewar 50, more vaporized carbon dioxide from the original liquid 58 will enter the headspace 56 of the master dewar 10 adding to the total gas delivery capacity of the bank. In addition, the contribution of between 3 and 5 pounds per hour of vapor from the pressure builder of the master dewar theoretically puts the combined output capacity of the system in FIG. 4 over 40 pounds per hour of continuous operation, which exceeds the theoretical output of two similar dewars connected in parallel in an evaporate-to-process configuration such as in FIG. 2.

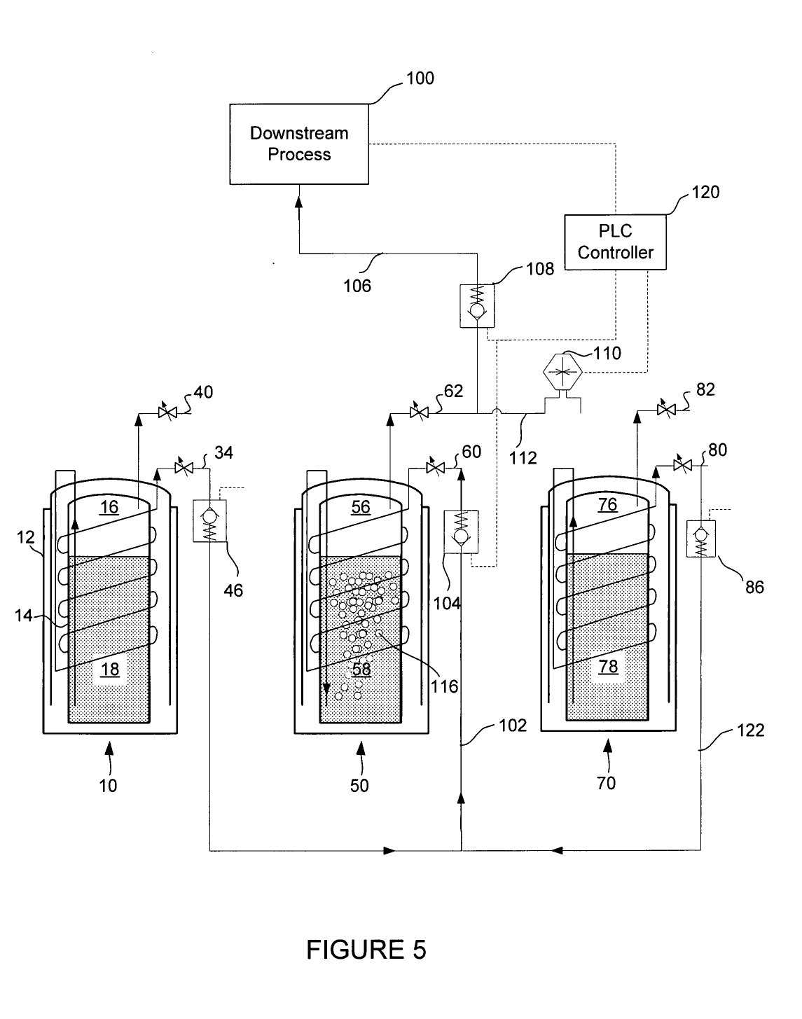

FIG. 5 illustrates an alternative embodiment comprising the system shown and described for FIG. 4 supplemented with a third dewar vessel 70 arranged as a second satellite dewar to the bank that includes satellite dewar 10 and master dewar 50. Gas withdrawal circuit 80 creates a flow path from liquid phase 78 out of dewar 70 and is plumbed to transfer line 122 via check-valve 86. From there it connects into transfer line 102 and proceeds to gas withdrawal circuit 60 of master dewar 50. Vent circuit 82 is not used.

Discussion of FIGS. 4 and 5 to this point represent the minimum, manually operated configuration necessary for the preferred and alternative embodiments of the present invention. Addition of active controls and sensors into the configurations shown in FIGS. 4 and 5 can dramatically improve the safety, control and scalability of operating the gas delivery system. Both figures include several components that serve these functions. Electronically activated valves as valve 104 on transfer line 102 and valve 108 on transfer line 106 respectively allow flow to be shut off in their corresponding transfer lines by automation when there is an error or no demand for the gas supply. A pressure sensing device 110 in communication with the flow of transfer line 106 via branching flow line 112 allows for monitoring the output pressure of the entire bank of dewars during operation. The pressure sensing device may be, for example, a single point pressure switch or a continuous gauge that delivers real-time pressure data. A PLC Controller 120 serves as an example of the automation control device. The PLC 120 optionally receives signals from downstream process 100 when flow is required and pressure signals from the pressure sensing device. The PLC 120 also controls the actuation of valves 104 and 108 to allow flow. Finally, the PLC 120 can optionally provide signals to the downstream process that an error state has occurred at the gas supply so the process controller can take appropriate action. Addition of electronically actuated valve 104 deals with a safety concern of connecting dewars in the described master/satellite configuration. When no flow demand exists, carbon dioxide can still be transferred from satellite dewars to the master dewar by evaporation and recondensation so long as the pressure of either satellite dewar is higher than the master dewar. This event carries the risk that the master dewar might become overfilled with liquid during periods where no gas is withdrawn for the master dewar headspace. Inclusion of valve 104 that is open only when the downstream process 100 demands flow eliminates this condition. In a similar manner valve 108 isolates the entire bank of dewars from other banks optionally operated by PLC controller 120. This allows the system to be scaled to multiple banks of dewars so that gas delivery may continue when one bank is depleted. Other examples of signals the PLC might use but not shown in the figures come from optional liquid level sensors of the dewars, gas sensing devices to test for process gas leaks; pump and process error signals to indicate downstream problems and human interface components such as reset buttons or configuration switches.

Referring again to FIGS. 4 and 5 and the process flowchart in FIG. 7, processes of the preferred and alternative embodiments are explained as follows. It is understood that the flow rates and data described herein are exemplary and will vary depending upon system implementation, operation, type of gas, and flow rates without varying from the scope of the present invention. The downstream process 100 periodically draws gas S210 at a time-averaged rate from vent circuit 62 on master dewar 50. In one test, downstream process 100 draws carbon dioxide gas at an instantaneous rate of 36 lb/hr with cycles of inactivity resulting in an average draw of 24 lb/hr from dewar 50. Gas withdrawal circuits used in the embodiments are designed to supply up to 18 lb/hr of carbon dioxide gas at 70° F. However, typical pressure builder circuits can only provide replacement vapor at the rate of approximately 3-6 lb/hr based on the age and degree of mechanical stress placed on a specific pressure builder circuit. Additional vapor will be supplied S210 to vent circuit 40 by evaporation of carbon dioxide from the bulk liquid 58 in master dewar 50.

During the process operation of withdrawing gas from dewar 50, withdrawal of gas vapor from headspace 56 causes gas from liquid 58 to evaporate. As the liquefied bulk gas 58 in master dewar 50 evaporates into headspace 56, the remaining bulk liquid 58 cools, decreasing the equilibrium pressure in headspace 56. As the pressure decreases, flow begins from either satellite dewar 10 or 70 depending on which headspace pressure, 16 or 76, is greater. If the headspace pressure in both dewars is close, flow may occur from both satellite dewars 10 and 70 simultaneously into master dewar 50. If only one dewar is present in the bank, then that dewar would be the sole contributor to liquid supply 58 in the master dewar. Alternatively, a pump (not shown) could transfer gas from a satellite dewar into gas withdrawal circuit 60. However, due to the forces created by the cooling effect in the master dewar, a pump is not necessary for many applications.

The gas from transfer line 102 is delivered S214 into dewar 50 through its own gas withdrawal circuit 60, which in the preferred embodiment has an 18 lb/hr capacity to deliver gas to bulk liquid 58. The resulting gas stream 116 bubbles through the liquid 58 and into headspace 56. Since the bulk liquid 58 of dewar 50 is significantly colder than the incoming gas flow stream, which has been exposed to the ambient room temperature, a portion of the incoming flow stream condenses, thereby delivering heat and agitation to the bulk fluid 58. The bubbling of the gas into bulk supply 24 also re-equilibrates the incoming vapor to the cooler temperature and further reduces the amount of impurity in the incoming vapor. Further, the trap effect will remove any entrained liquids or solutes from the incoming gas flow stream into master dewar 50 from satellite dewars 10 or 70 if the gas contains such impurities.

The system is periodically monitored S216, either manually or by the PLC, for correct pressure. So long as pressure remains above the minimum threshold, the system continues delivering gas. If pressure falls below the required minimum, action must be taken to continue the gas service. In single satellite dewar configurations, when the system no longer has sufficient pressure, a manual or PLC based determination is made S220 to determine if the master cylinder has sufficient liquid to accept another satellite dewar. If so, another dewar is supplied S222 and delivery continues S218. If not the bank is depleted and in a larger PLC based system, the process continues S224 and an alternate supply is selected.

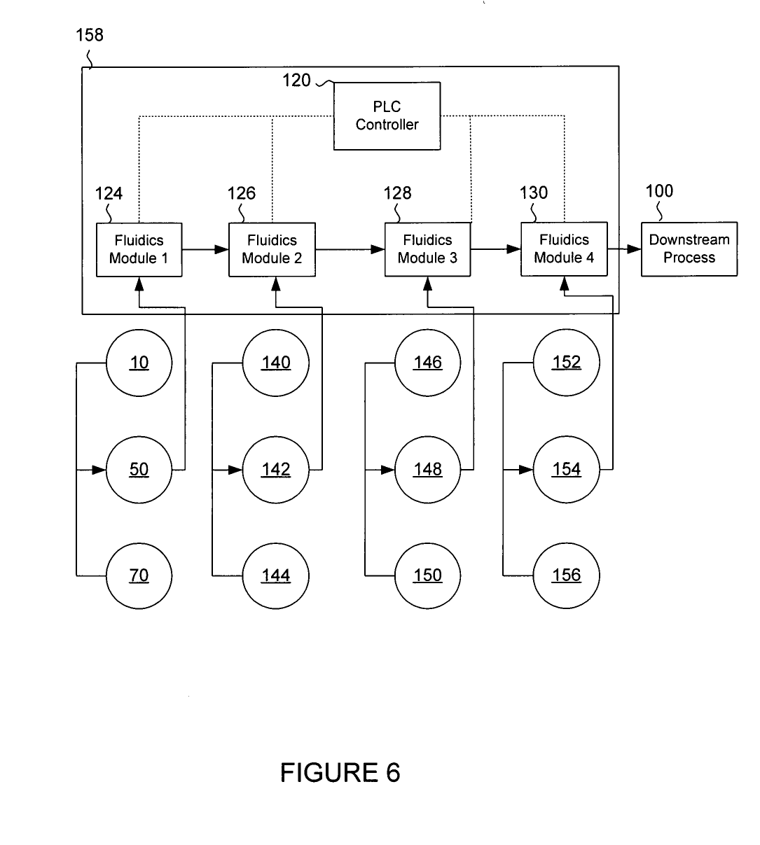

FIG. 6 illustrates an additional embodiment of multiple banks of dewars that supply gas to a downstream application. Dewar-based controller 158 comprises a master PLC-based module 120 (S226) and preferably at least one fluidic module 124, but alternatively may include any number of modules S228. In the system shown in FIG. 6, gas withdrawal circuits and pressure builder circuits are part of each dewar vessel but are not shown in the drawing for clarity. Further, not shown are active and passive check valves that isolate the dewar gas withdrawal circuits between dewars during inactivity of a downstream process although these components are commonly housed within the fluidic module shown. These devices are described in relation to the preferred and alternative embodiments shown in FIGS. 4 and 5 and incorporated by reference into the dewars of FIG. 6. FIG. 6 illustrates up to four fluidic modules 124-130, each controlling one bank of two, or alternatively three dewars. In an implementation of exemplary controller 158, no auxiliary bank switching is available to the system. “Fluidics Module 1” (124) receives S230 a gas flow stream from master dewar 50, which is arranged to receive flow streams from satellite dewar 10 or alternatively dewar 70. Fluidics modules 124-130 are arranged S230 in similar design, for example “Fluidics Module 2” (126) receives a gas flow stream from master dewar 142, which is arranged to receive flow streams from satellite dewars 140 and 144. The fluidics modules 124-130 are connected with gas flow paths arranged in series S232 beginning with Module 1 (124) and ending with Module 4 (130) that is connected S234 to feed gas to downstream process 100. Alternatively, each Fluidic Module 1 through 4 could be controlled by PLC 120 to be drawn from in any order, provided that the transfer lines from each Module are individually manifolded into a supply line for downstream process 100.

Two exemplary of modes of process operation S236 are performed by controller 158. In the first mode, individual fluidic modules 124-130 are treated as individual banks S238. Beginning with the first module 124, the bank of dewars connected to the module is operated and gas is withdrawn S240 until the minimum pressure limit required by the downstream process is reached. An example of a minimum pressure limit in master dewar 50 is 200 psi. Once minimum pressure is reached in a first bank, the next sequential bank is selected S242, which is the bank connected to Fluidics Module 2 (126). A depleted bank of dewars may be reset by the operator by replacing the necessary dewars and resetting the bank's fluidic module, for example by depressing a reset button on the module.

In the embodiment for a controller 158, one to four fluidic modules, with each module controlling two or more dewars, are connected to the master programmable logic controller (PLC) 120. When all of the connected banks are depleted, an error signal is generated in PLC 120 that can be transmitted to downstream process 100.

A second mode S236 of operation of controller 158 requires a full implementation of four fluidic modules 124-130. In this mode, fluidic modules one 124 and two 126 are grouped S244 as a single first bank, and modules three 128 and four 130 are grouped as a single second bank. In the preferred operations, each bank should have the same number of dewars, such as the two or three dewars per bank in the preferred and alternative embodiments. Modules within a bank are selected alternately or in parallel S246 depending on the duty cycle of downstream process 100. A bank is considered empty when both fluidic modules fall below the minimum inlet pressure to downstream process 100. When one bank is depleted, the second bank is engaged S248 by PLC 120 to supply gas to downstream process 100. For example, when a bank that consists of modules 124 and 126 is depleted, a second bank that consists of modules 128 and 130 is engaged to provide the gas flow. Whenever a depleted bank of dewars has been replaced with re-filled dewars, the fluidics module associated with the bank must be reset to an active state and the active signal must be received by the PLC 120 prior to the use of the re-filled bank.

Testing of Exemplary Systems

Two levels of testing were performed on the exemplary systems. The first test utilized a single bank of three dewars supplying between 30 and 36 lb/hr (250 to 300 mL/min) of carbon dioxide gas to a downstream process. The second test was repeated for a single bank of two dewars supplying carbon dioxide at 24 lb/hr (200 mL/min). Tests were run from the dewar initial pressure state of approximately 300 to 350 psi until the PLC-controlled fluidics module reported that a minimum pressure in the bank was reached. Individual dewars were weighted prior to the start of each test and after the end of each test. Based on the difference in weight of each dewar, the percent of carbon dioxide usage was calculated in each test. For the entire range of operation, the exemplary systems were able to continuously supply the minimum pressure required to allow a standard commercial booster pump system to maintain a minimum pressure of 200 psi to downstream carbon dioxide booster pumps.

The results of the three dewar bank test are as follows. The test terminated after twenty-seven hours of continuous operation. The test used a MultiGram II and a MultiGram III supercritical fluid chromatography system that are manufactured by Mettler-Toledo Autochem, Inc. as downstream applications to create gas flow demand. Total flow rates from 250 to 300 mL/min were used for the durations listed in the following table:

| Flow | Time | Demand | Calc wt |
|---|---|---|---|
| (mL/min) | (hrs) | (lb/hr) | CO2 (lb) |
| 270 | 3 | 34.4 | 103.2 |
| 300 | 6 | 36 | 216 |
| 250 | 18 | 30 | 540 |
| Total -> | 27 | 33.5 | 859.2 |

Actual usage for this period was found to be 990 lb, or 83.7% of the usable capacity of the three dewars. The variance is largely attributed to a leaky overpressure check valve that bled continuously until one of the satellite dewar's pressure dropped below 250 psi and some preliminary experiments performed the prior day. Presumably, if the extraneous loss had not occurred, the carbon dioxide lost would have extended pumping time by about four hours.

The following table shows how the carbon dioxide use was distributed between the three dewars in the bank. Dewars are labeled as dewars “1,” “2,” and 3” In this test, dewar 1 is the master dewar that was selected to supply vapor to the downstream processes. Dewars 2 and 3 are the satellite dewars that supply dewar 1 with carbon dioxide. Dewar 1 resulted in the lowest percent use of available carbon dioxide from its bulk supply. This is a beneficial effect since the vapor from the two satellite dewars was then continuously re-equilibrated through an appreciable volume of liquid carbon dioxide in dewar 1. In operation, the two satellite dewars were observed to cycle, or take turns supplying the master dewar with carbon dioxide, in terms of which dewar had the relative higher pressure.

| | | | | | | Total | | | Residual | % use |
|---|---|---|---|---|---|---|---|---|---|---|
| | | Init | Final | Init | Unavailable | Available | Used | Residual | Available | of avail |
| Dewar | Tare | Wt | Wt | CO2 | CO2 | CO2 | CO2 | CO2 | CO2 | CO2 |
| 1 | 297 | 710 | 454 | 413 | 16 | 397 | 256 | 157 | 141 | 64.5% |
| 2 | 305 | 696 | 372 | 391 | 16 | 375 | 324 | 67 | 51 | 86.4% |
| 3 | 335 | 762 | 352 | 427 | 16 | 411 | 410 | 17 | 1 | 99.8% |
| Total | 937 | 2168 | 1178 | 1231 | 48 | 1183 | 990 | 241 | 193 | 83.7% |

The results of the two dewar bank test are as follows. The test terminated after 21.5 hours of continuous operation. The test used one MultiGram III SFC system operating at 198 mL/min carbon dioxide flow to create flow demand. The dewar usage for the two dewar test is reported in the following table:

| | | | | | | Total | | | Residual | % use |
|---|---|---|---|---|---|---|---|---|---|---|
| | | Init | Final | Init | Unavailable | Available | Used | Residual | Usable | of avail |
| Dewar | Tare | Wt | Wt | CO2 | CO2 | CO2 | CO2 | CO2 | CO2 | CO2 |
| 1 | 308 | 706 | 330 | 398 | 16 | 382 | 376 | 22 | 6 | 98.4% |
| 2 | 265 | 664 | 530 | 399 | 16 | 383 | 134 | 265 | 249 | 35.0% |
| | | | | | | 0 | | | | |
| Total | 573 | 1370 | 860 | 797 | 32 | 765 | 510 | 287 | 255 | 66.7% |

The results of the two dewar test show full usage of the satellite dewar and 35% usage of the master dewar. With this amount of residual carbon dioxide, it is preferable that a second satellite dewar be fitting to the system without replacing the master dewar and continue running. This arrangement will drain the master dewar to approximately 30% which is the recommended minimum level. The utilization for the three dewars used in the test would then approach 90%.

Although the minimum configuration could consist of a single fluidic module with one master and one satellite dewar, a standard configuration will automatically switch between banks when one is depleted. This also provides for the automated replacement of one bank while the system is operating, resulting in no down-time to a downstream process.

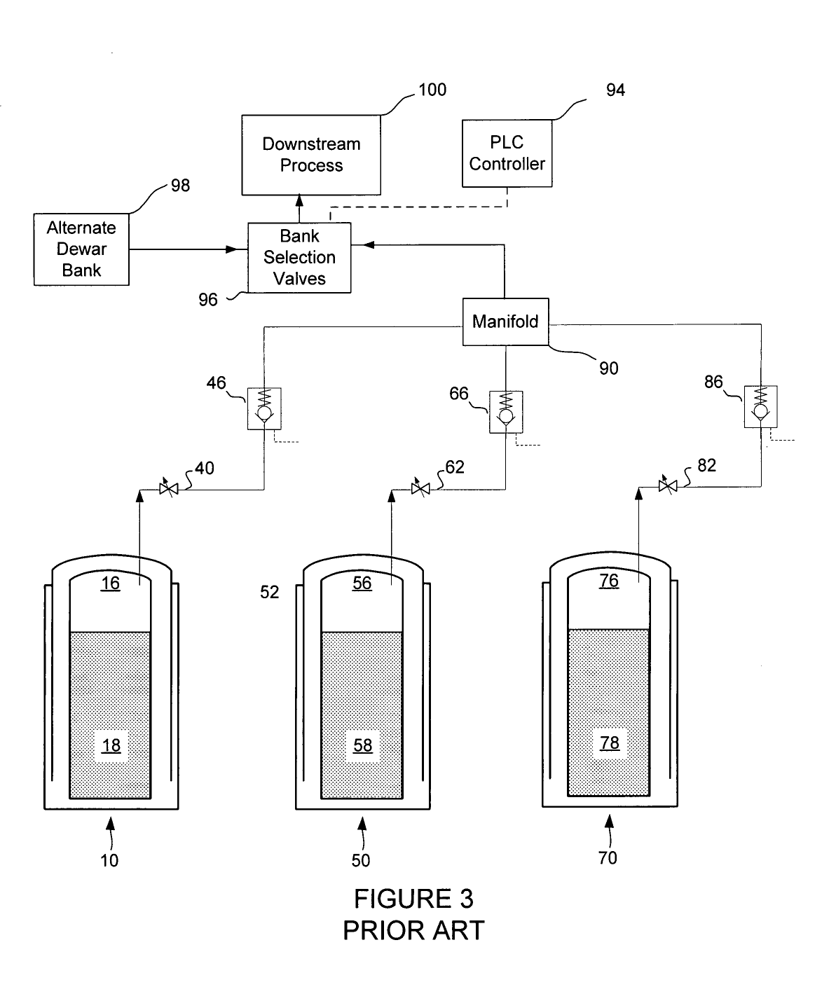

The embodiments of the present invention can be used to supply a downstream SFC process. The table below can be used to determine the number of systems that can be run from different configurations. A listing of the carbon dioxide use at different flow compositions containing different modifier concentrations is listed for each process flow stream rate. Flow demand was created by using various chromatography systems manufactured by Mettler-Toledo Autochem, Inc. As can be seen from the table, multiple implementations of the many of these systems can easily exceed the capacity of the original system shown in FIG. 3. The need for higher capacity systems as in FIGS. 4 and 5 becomes clear.

CO2 Use (lb/hr)

Modifier Concentration

| flow | mL/min | 0% | 5% | 10% | 25% |
|---|---|---|---|---|---|
| Analytical | 5 | 0.6 | 0.57 | 0.54 | 0.45 |
| MiniGram | 10 | 1.2 | 1.14 | 1.08 | 0.9 |
| AutoPrep | 50 | 6 | 5.7 | 5.4 | 4.5 |
| MG II | 70 | 8.4 | 7.98 | 7.56 | 6.3 |
| MG III | 200 | 24 | 22.8 | 21.6 | 18 |

One skilled in the art will appreciate that the present invention can be practiced by other than the described embodiments, which are presented for purposes of illustration and not limitation, and the present invention is limited only by the claims that follow.

What is claimed is:

1. A system for delivery of a gas, comprising:
a first storage vessel holding a supply of a liquefied gas under pressure, comprising a pressure builder circuit, a vent circuit and a gas withdrawal circuit; and
a second pressurized vessel holding a supply of the liquefied gas under pressure, comprising a pressure-builder circuit and a gas withdrawal circuit that is connected to the gas withdrawal circuit of the first pressurized vessel.

2. The system of claim 1, wherein the connection is arranged so that the gas is transferred from the gas withdrawal circuit of the second vessel into the gas withdrawal circuit of the first vessel.

3. The system of claim 1, further comprising:
a third pressurized vessel holding bulk liquefied gas under pressure, comprising a gas withdrawal circuit that is connected to the gas withdrawal circuit of the first pressurized vessel.

4. The system of claim 3, wherein gas is transferred to the gas withdrawal circuit of the first vessel from either the second vessel or the third vessel that has a higher relative gas pressure.

5. The system of claim 1, wherein the gas withdrawal circuit of the first vessel comprises a dip tube that delivers incoming gas into a liquid phase of the bulk gas inside the vessel.

6. The system of claim 1, further comprising:
a downstream application, connected to the vent circuit,
wherein the application draws bulk gas from the vent circuit that is a mixture of gas vapor from the first vessel and from the second vessel.

7. The system of claim 1, wherein the gas transfer is performed passively.

8. A system for delivery of a gas, comprising:
a first bank of gas storage vessels, controlled by a first fluidic module
a second bank of gas storage vessels, controlled by a second fluidic module,
wherein each bank comprises a first storage vessel holding bulk liquefied gas under pressure, comprising a vent circuit and a gas withdrawal circuit and a second pressurized vessel holding bulk liquefied gas under pressure, comprising a gas withdrawal circuit that is connected to the gas withdrawal circuit of the first pressurized vessel, and
wherein a master controller operates each fluidic module to deliver gas from a bank to an application.

9. The system of claim 8, wherein when one of the banks is depleted, the master controller switches to a bank that is not depleted.

10. The system of claim 8, wherein the master controller operates each bank together as a single grouped bank to deliver gas to the application,
wherein the bank with the highest relative pressure in the grouped bank delivers pressure to the application at a time period.

11. A process for delivering gas, comprising:
preparing a first pressurized vessel, comprising a gas withdrawal circuit and a vent port, containing a supply of a liquefied gas;
preparing a second pressurized vessel, comprising a gas withdrawal circuit, containing a supply of the liquefied gas;
connecting the gas withdrawal circuit of the first vessel to the gas withdrawal circuit of the second vessel; and
transporting a quantity of vaporized gas out of a gas withdrawal connection of the second vessel's gas withdrawal circuit and into a gas withdrawal connection of the first vessel's gas withdrawal circuit.

12. The process of claim 11, wherein the transporting is performed passively.

13. The process of claim 11, further comprising:
directing the transported gas through the first vessel's gas withdrawal circuit that extends into a liquefied phase of the gas of the first pressurized vessel.

14. The process of claim 11, further comprising:
providing a third pressurized vessel holding bulk liquefied gas under pressure, comprising a gas withdrawal circuit that is connected to the gas withdrawal circuit of the first pressurized vessel.

15. The process of claim 14, wherein whichever of the first or the third vessel has the highest relative pressure determines whether gas is transported from the first vessel or the second vessel to the gas withdrawal circuit of the first vessel.
